(19) United States
(12) Patent Application Publication
(10) Pub. No.: US 2009/0107721 A1
(43) Pub. Date: Apr. 30, 2009

(54) PARTIAL DIRECT WIRE ATTACH

(75) Inventors: WILLIAM A. MILLER, Camas, WA (US); ANTHONY P. DeLUCCO, Beaverton, OR (US)

Correspondence Address: MARGER JOHNSON & MCCOLLOM, P.C., 210 SW MORRISON STREET, SUITE 400, PORTLAND, OR, 97204, US

(73) Assignee: EFFICERE INC., Vancouver, WA (US)

(21) Appl. No.: 12/260,047

(22) Filed: Oct. 28, 2008

Related U.S. Application Data
(60) Provisional application No. 60/983,918, filed on Oct. 30, 2007.

(51) Int. Cl. H01R 9/05

(52) U.S. Cl. 174/75 C

(57) ABSTRACT

A cable assembly including a cable, a ferrule, and a stringer. The cable includes a center conductor; a dielectric disposed around the center conductor; and a shield disposed around the dielectric. The ferrule is electrically connected to the shield and disposed around a portion of the dielectric exposed by the shield. The stringer includes an opening where the ferrule is disposed in the opening.

### CROSS REFERENCE TO RELATED APPLICATIONS

This application claims the benefit of from U.S. provisional patent application Ser. No. 60/983,918 filed Oct. 30, 2007, titled Partial Direct Wire Attach, the contents of which we incorporate in its entirety.

### BACKGROUND

Coaxial cables can have a center conductor surrounded by a dielectric, which in turn is surrounded by a shield. The center conductor and the shield form conductors of a transmission line. The relationship of the center conductor to the shield affects various electrical parameters of the transmission line.

Unfortunately, when a coaxial cable is mounted to a printed circuit board, in particular a coaxial cable with a braided wire shield, the shield is pulled away from the center conductor and dielectric. The shield may be re-formed and soldered to the printed circuit board. As a result, the spatial relationship of the center conductor and the shield is changed, introducing reflections, insertion loss, distortions, or the like.

### BRIEF DESCRIPTION OF THE DRAWINGS

FIG. 1 is a cross-sectional view of a cable according to an embodiment.

FIG. 2 is a cross-sectional view of a ferrule according to an embodiment.

FIG. 3 is a plan view of the ferrule of FIG. 2.

FIGS. 4 and 5 are cross-sectional views of ferrules according to other embodiments.

FIG. 6 is a cross-sectional view of the cable of FIG. 1 mated with the ferrule of FIG. 2.

FIG. 7 is a top view of a stringer according to an embodiment.

FIG. 8 is a side view of the stringer of FIG. 7.

FIG. 9 is a front view of the stringer of FIG. 7.

FIG. 10 is a cross-sectional view of the mated cable and ferrule of FIG. 6 and the stringer of FIG. 7.

FIG. 11 is a cross-sectional view of the assembly of FIG. 10 mated with a substrate according to an embodiment.

FIG. 12 is a plan view of the assembly of FIG. 11.

FIG. 13 is a cross-sectional view of multiple cables mated with a substrate according to an embodiment.

FIG. 14 is a plan view of an assembly according to another embodiment.

FIG. 15 is a cross-sectional view of multiple cables mated with a substrate according to another embodiment.

FIG. 16 is top view of a stringer for multiple cables according to an embodiment.

FIG. 17 is a flowchart illustrating a process for assembling cables to a board according to an embodiment.

### DETAILED DESCRIPTION

Embodiments will be described with reference to the drawings. Embodiments allow the termination of a cable on to a substrate while maintaining the integrity electrical characteristics of a transmission line formed by the cable.

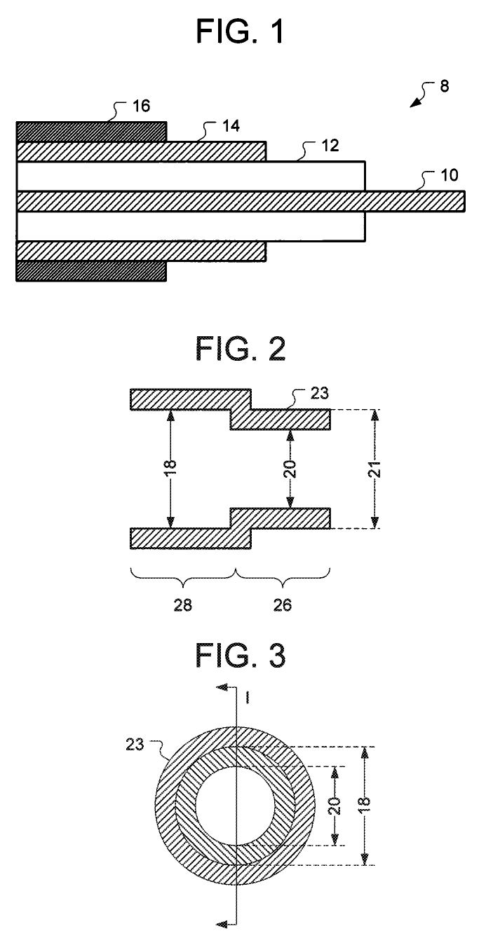

FIG. 1 is a cross-sectional view of a cable 8 according to an embodiment. Center conductor 10 is surrounded by dielectric 12. Shield 14 surrounds the dielectric 12 and forms the reference conductor for the cable 8. A jacket 16 can surround the shield 14. In this embodiment, the center conductor 10 is exposed, extending beyond the dielectric 12. Similarly, the dielectric 12 is exposed, extending beyond the shield 14. In addition, the shield 14 is exposed, extending beyond the jacket 16.

FIG. 2 is a cross-sectional view of a ferrule according to an embodiment. As used herein, a ferrule is a structure that can be attached to a shield 14 of a cable 8. Although a ferrule can refer to a structure used in press-fit, compression, crimped, or other similar connections, as used herein, a ferrule need not be used or even capable of being used in such a connection. The ferrule may alternatively be referred to as a sleeve. In this embodiment, the ferrule 23 is substantially cylindrical in shape. The view of FIG. 2 is a cross-section along the length of the ferrule 23. The inner diameter of the ferrule 23 is not the same throughout the ferrule 23. In region 28, the ferrule 23 has an inner diameter 18. The inner diameter 18 can be substantially equal to the outer diameter of the shield 14 of the cable 8. Although described as substantially equal, the inner diameter 18 can be greater than the outer diameter of the shield 14. For example, the inner diameter 18 can be greater than the outer diameter of the shield 14 such that the shield can be inserted into the ferrule 23 in region 18 with sufficient space to reliably insert the shield 14 without damage. In another example, sufficient space can remain for solder, conductive epoxy, or the like to secure and/or electrically connect the shield 14 to the ferrule 23.

In region 26, inner diameter 20 is substantially equal to the outer diameter of the dielectric 12. Similar to the inner diameter 18, the inner diameter 20 can be greater than the outer diameter of the dielectric 12.

Region 26 can be substantially as long as the exposed dielectric 12. Similarly, region 28 can be substantially as long as the exposed shield 14. In another embodiment, the length of region 28 can be less than the length of the exposed shield 14.

The ferrule 23 can be formed of any conductive material. For example, the ferrule 23 can be formed of gold plated brass. In an embodiment, the conductive material can be selected for its solder-ability and/or bond-ability.

FIG. 3 is a plan view of the ferrule of FIG. 2. The cross-section of FIG. 2 was taken along line I. In this embodiment, the ferrule 23 has a substantially cylindrical shape. However, the ferrule 23 can have other shapes. For example, the dielectric 12 of the cable 8 can have an elliptical shape. Accordingly, the ferrule 23 can have a corresponding elliptical shape.

Moreover, the outer shape of the ferrule 23 can, but need not be similar to the inner shape of the ferrule 23. For example, the inner shape of the ferrule 23 can be a cylindrical shape while the outer shape of the ferrule 23 can be a rectangular shape.

Furthermore, the ferrule 23 can, but need not have a substantially uniform thickness. Referring back to FIG. 2, the cross-section illustrates that the ferrule 23 has a substantially uniform thickness. That is, the ferrule 23 can follow the contours of the cable 8 of FIG. 1. In another embodiment, the outer shape of the ferrule 23 can be consistent along its length. For example, the outer shape of the ferrule 23 can be a substantially uniform cylinder, while the inner shape of the ferrule 23 can be stepped as illustrated in FIG. 2.

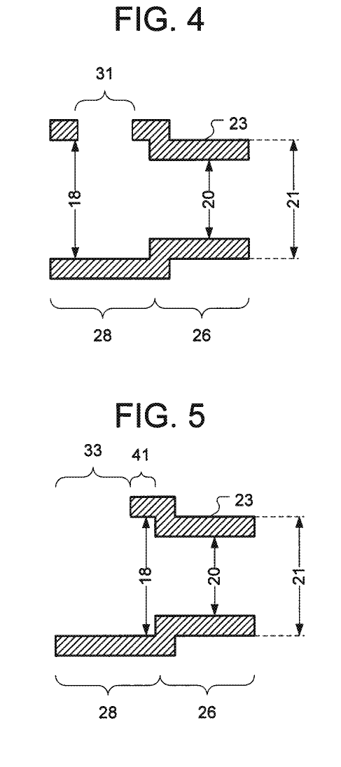

FIGS. 4 and 5 are cross-sectional views of ferrules according to other embodiments. Referring to FIG. 4, an opening 31 can penetrate the ferrule 23. For example, the opening 31 can penetrate the ferrule 23 in region 28. Accordingly, when assembled with a cable 8 as will be described below, solder can be applied through the hole to the shield 14. Referring to FIG. 5, a different opening 33 extends from an edge of the ferrule 23 to where the inner diameter of the ferrule 23 steps from inner diameter 18 to inner diameter 20. In an embodiment, a lip 41 can remain extending from the inner diameter step. When assembled with a cable 8 as will be described below, the shield 14 can extend below the lip 41. The shield 14 can be attached to the ferrule 23 substantially continuously around the perimeter of the lip 41. As a result, even though the ferrule 23 does not surround the shield equally on all sides, an electrical connection of the shield 14 to the ferrule 23 can still be made around the perimeter of the shield 14, maintaining the integrity of the reference plane formed by the shield, while still providing increased access to the shield 14 for soldering.

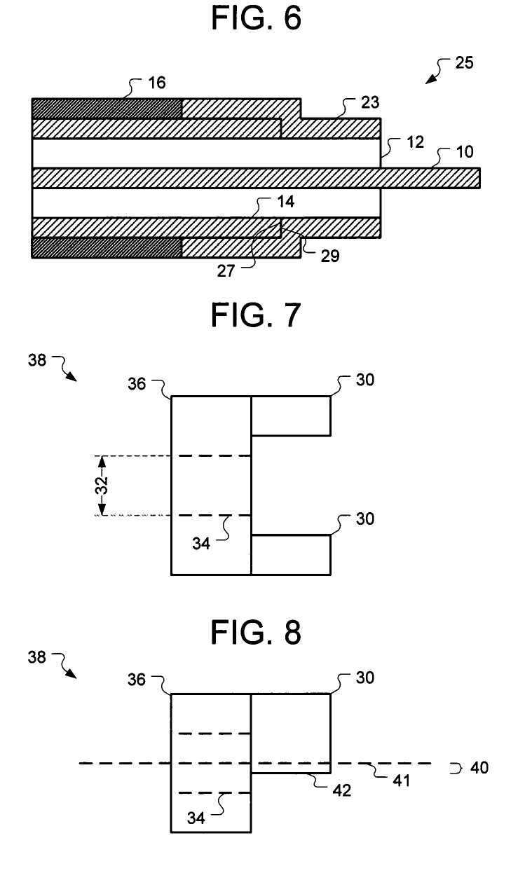

FIG. 6 is a cross-sectional view of the cable 8 of FIG. 1 mated with the ferrule 23 of FIG. 2. In this embodiment, the lengths of the ferrule in regions 26 and 28 are substantially equal to the exposed shield 14 and dielectric 12, respectively. When assembled into assembly 25, the surface 27 of the shield 14 and the surface 29 of the ferrule 23 can contact each other. In an embodiment, solder, conductive epoxy, or the like can join surfaces 27 and 29 together. Accordingly, the transmission line of cable 8 has a substantially continuous outer conductor formed by the shield 14 and the ferrule 23.

Although the jacket 16 has been illustrated as being in contact with the ferrule 23, the jacket 16 need not contact the ferrule 23. For example, region 28 of the ferrule 23 can have a length that is less than the length of the exposed shield 14. Accordingly, when it is assembled with the ferrule 23, the ferrule will not reach the jacket 16. In an embodiment, an amount of the shield 14 that is exposed can be used for the application of solder, verification of solder quality, or the like.

FIG. 7 is a top view of a stringer 38 according to an embodiment. A stringer is a structure to interface a cable to a substrate. In an embodiment, the stringer can provide a connection between a reference conductor formed by a shield 14 of a cable 8 and a corresponding reference conductor on the substrate. Furthermore, the stringer can provide a connection between multiple reference conductors of multiple cables to each other and to one or more reference conductors on the substrate. In the embodiment illustrated in FIG. 7, the stringer 38 includes a body 36. An opening 34 penetrates the body 36. The opening has a diameter 32. The diameter 32 can be substantially equal to the outer diameter 21 of the ferrule 23.

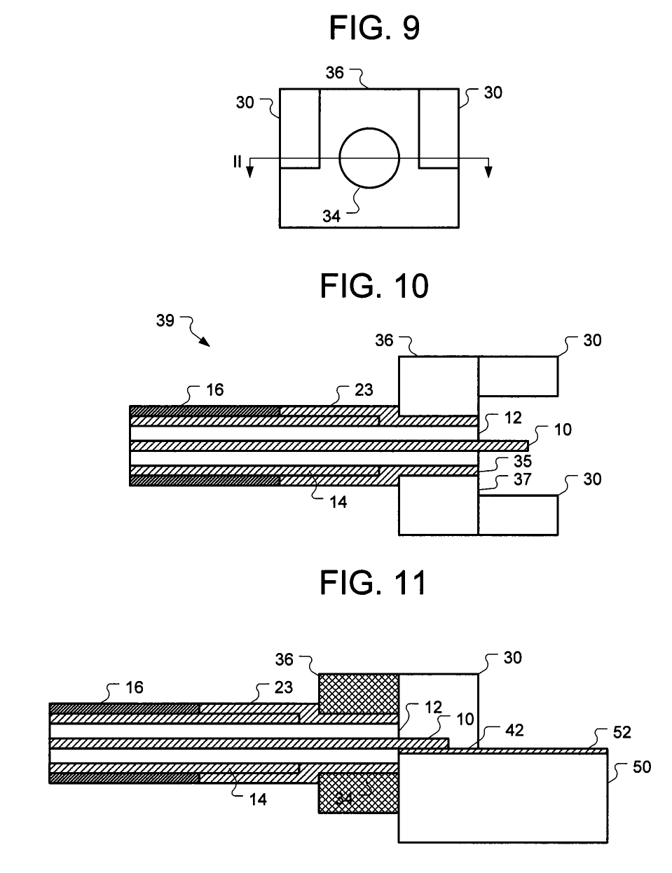

The stringer 38 includes dividers 30. In this embodiment, one divider 30 is on either side of the opening 34. FIG. 8 is a side view of the stringer of FIG. 7. Axis 41 is the centerline of the opening 34. A surface 42 of the divider 30 extends below the axis 41 by a distance 40. In an embodiment, the distance 40 can be substantially equal to one half of a diameter of the center conductor 10. As a result, the surface 42 would be in the same plane as a lower surface of a center conductor 10. In other embodiments, the surface 42 of the divider 30 can be disposed at a different location depending on the features of the substrate on which the stringer 38 is to be mounted. FIG. 9 is a front view of the stringer of FIG. 7.

The stringer 38 can be formed of a conductive material. For example, the stringer 38 can be a gold plated metal such as brass, copper, aluminum, or the like. Similar to the ferrule 23, the stringer 38 material can be selected for solder-ability, and/or bond-ability.

FIG. 10 is a cross-sectional view of the mated cable 8 and ferrule 23 of FIG. 6 and the stringer of FIG. 7. The cross-section is along line II of FIG. 9. The ferrule 23 is inserted into the opening 34. The ferrule 23 can be secured by friction, solder, conductive epoxy, or the like. Any connection that yields an electrical connection can be used.

Furthermore, in this embodiment, the step in the outer diameter of the ferrule 23 acts as a stop when the assembly 25 is inserted into the opening 34. The ferrule 23 can have other structures in combination with or in alternative to the step to aid in aligning the assembly 25 to the stringer 38.

The ferrule 23 can have a length such that a surface 35 of the ferrule 23 is substantially flush with a surface 37 of the body 36 on the same side as the dividers 30. Accordingly, the transmission line of cable 8 has a substantially continuous reference conductor from the shield 14 internal to the cable 8 to the end of the dielectric at the surface 27. Thus, when forming a connection between the cable 8 and a substrate, the shield 14 need not be unbraided, removed from the dielectric, or otherwise disturbed to connect the cable 8 to a substrate such as a printed circuit board. The function of the reference conductor can transition from the shield 14, to the ferrule 23, to the stringer 38, and eventually to a substrate. In an embodiment, the ferrule 23, dielectric 12, and center conductor 10 each can have different or similar lengths to change the electrical characteristics of the transition. That is, the surface 35 of the ferrule 23, the surface 37 of the body, or a surface of the dielectric, individually or in combination, can be offset to achieve a desired electrical performance.

FIG. 11 is a cross-sectional view of the assembly 39 of FIG. 10 mated with a substrate according to an embodiment. Although the divider 30 has been illustrated in this cross-sectional view, the divider 30 is in a different plane than the remainder of the cross-section. The divider 30 has been illustrated for reference and the body 36 has been shaded for contrast. The assembly 39 is mated with a substrate 50. The substrate 50 can be any substrate that can support transmission lines. For example, the substrate 50 can be a printed circuit board. In another example, the substrate 50 can be a ceramic wafer bonded to a metal plate.

The substrate 50 includes a conductive layer 52. Signal traces, reference planes, or the like can be formed in conductive layer 52. The assembly 39 is mated with the substrate 50 such that a side of the center conductor 10 contacts the conductive layer 52. Similarly, the surface 42 of the dividers 30 can contact the conductive layer 52.

Although the center conductor 10 and dividers 30 have been described as contacting the conductive layer 52, one or all of the center conductor 10 and dividers 30 may not be directly connected to the conductive layer. For example, the center conductor 10 and dividers 30 may be offset from the conductive layer 52, yet soldered to the conductive layer 52 to create an electrical contact. In an embodiment, the center conductor 10 can be bent down to contact the conductive layer 52.

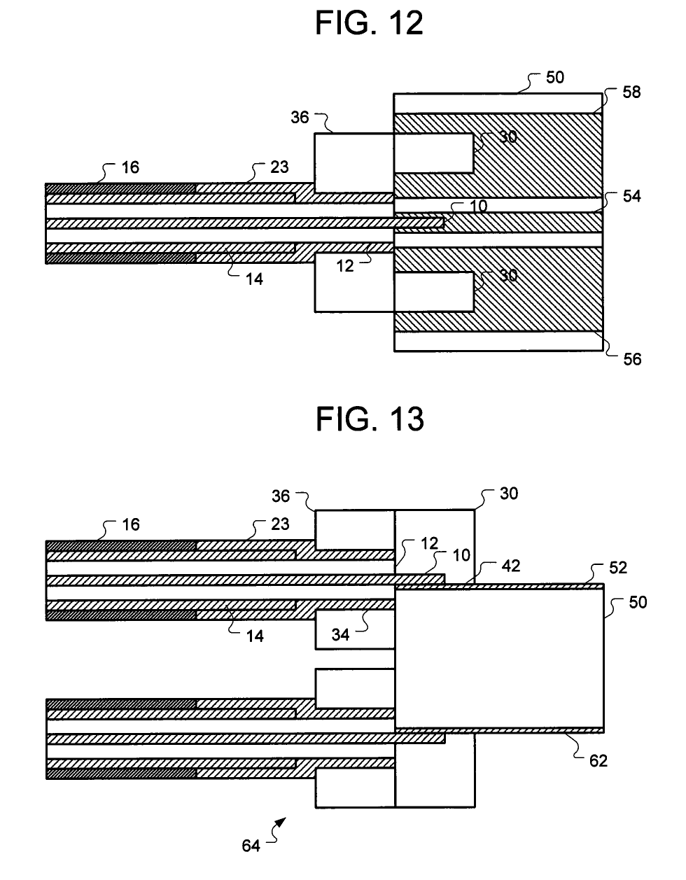

FIG. 12 is a plan view of the assembly of FIG. 11. The conductive layer 52 of FIG. 11 is divided into a signal line 54 and two ground planes 56 and 58. In this embodiment, signal line 54 and ground planes 56 and 58 form a coplanar waveguide on the substrate 50. Thus, the transition from a cable 8 to a transmission line on a substrate 50 has been made without a discontinuity associated with moving the shield 14 from the dielectric 12. Although a coplanar waveguide has been used as an example, the transmission line can be any variety of transmission lines. For example, the transmission line can be a microstrip line, a grounded coplanar waveguide, a stripline, or the like.

Although a coaxial cable has been used as an example of a cable 8, other types of cables, transmission lines, waveguides, or the like can be used. For example, any shielded cable, such as a twin coaxial cable can be used. In another example, a shielded twisted pair can be used.

FIG. 13 is a cross-sectional view of multiple cables mated with a substrate according to an embodiment. In this embodiment, the substrate 50 includes a second conductive layer 62 on an opposite side. An assembly 64 of a cable 8, ferrule 23, and stringer 38 are mated to the substrate 50 such that the center conductor 10 and dividers 30 of the assembly 64 can contact the conductive layer 62 as described above. Accordingly, multiple connections between cables 8 and transmission lines can be formed.

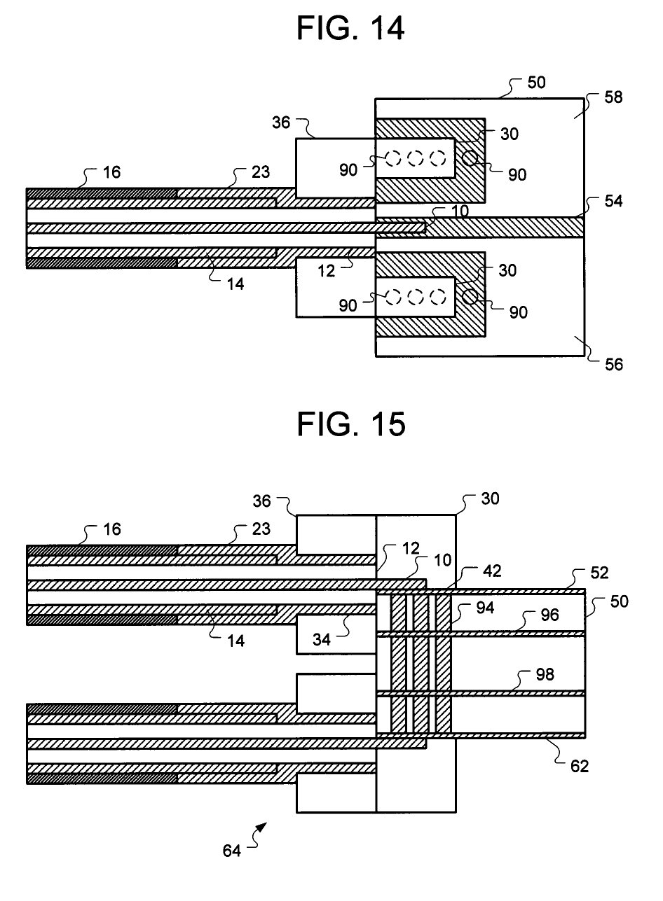

FIG. 14 is a plan view of an assembly according to another embodiment. In this embodiment, the transition is from the cable 8 to a microstrip line rather than a coplanar waveguide. Accordingly, vias 90 make a connection between the dividers 30 and a reference plane on another layer of the substrate. For example, the vias 90 can make a connection to an internal reference layer within the substrate 50. In another example, the vias 90 can pass through to the other side of the substrate 50.

FIG. 15 is a cross-sectional view of multiple cables mated with a substrate according to another embodiment. Similar to the embodiment of FIG. 14, vias 94 are used to connect the dividers 30 to particular reference planes internal to the substrate 50. Reference plane 96 can be the reference plane for signals on conductive layer 52. Reference plane 98 can be the reference plane for signals on conductive layer 62. The vias 94 can make an electrical connection between the dividers 30 and the corresponding reference planes. In addition, the vias 94 can make an electrical connection through the substrate 50 between dividers 30. Accordingly, the stringers 38 used on either side of the substrate can be electrically coupled together.

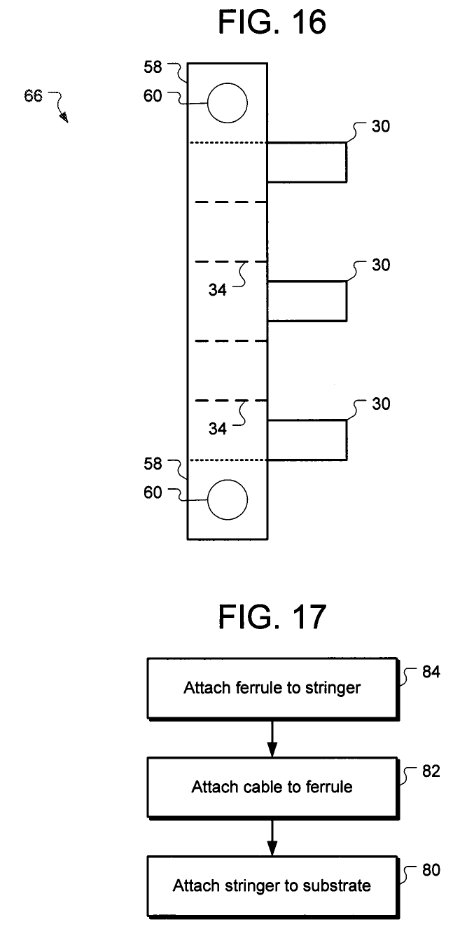

FIG. 16 is top view of a stringer for multiple cables according to an embodiment. The stringer 38 described above can be used with one cable 8. However, multiple connections through multiple cables may be needed to a substrate 50. A single stringer 66 can include multiple openings 34 for multiple cables. In this example, two openings 34 penetrate the stringer 66 for the attachment of cables. Accordingly, the stringer 66 can facilitate the attachment of multiple cables 8 to a substrate 50.

Furthermore, in an embodiment, the dividers 30 reduce electromagnetic radiation from the center conductors 10 of signals in the cables 8 passing through the stringer 66. For example, as described above, the dividers 30 can be attached to a reference plane for a transmission line. Accordingly, the dividers 30 themselves act as the reference plane. Radiation from an exposed center conductor 10 that would otherwise radiate would be blocked by the dividers 30. Accordingly, the dividers 30 can reduce an amount of emitted electromagnetic radiation.

In addition, the height and shape of the dividers 30 can be selected to affect the electrical characteristics of the transition. In an embodiment, the dividers 30 extend farther from the body 36 than the center conductor 10. Accordingly, in the region of the transition from the stringer 66 and the substrate 50, the shape, length, or the like of the center conductor 10 can have a reduced impact on the electrical characteristics of the transmission line beyond the dividers 30. In another example, the dividers 30 can extend partially or completely over the center conductor 10. Thus, the dividers 30, although described discretely, can form one continuous structure with openings for the center conductor 10.

The dividers 30 can also increase isolation between multiple center conductors 10. For example, radiation from one center conductor 10 that could cause crosstalk on another center conductor 10 passing through stringer 66 can be reduced or blocked by the divider 30 separating the two center conductors 10. The shape and height of the dividers 30 can be selected to reduce the crosstalk between the center conductors 10.

As described above, a variety of techniques can be used to attach a stringer to a board. In FIG. 16, stringer 66 has flanges 58 through which a hole 60 permits a fastener to be used to secure the stringer 66 to the substrate 50. For example, a pin could be inserted trough the hole 60 to fasten the stringer 66 to the substrate. In another example, referring to both FIGS. 13 and 16, two stringers 66 with flanges 48 could be disposed on opposite sides of a substrate. A first stringer 66 could have screw threads in its holes 60. A screw can be inserted through the hole 60 in a second stringer 66 and secured in the threaded holes 60 of the second stringer 66.

In an embodiment, the flanges 58 can be formed to be break-away flanges. For example, a stringer 66 can be mounted to a substrate 50 using the flanges 58 for alignment. Once assembled to the substrate 50, the flanges 58 can be broken away, narrowing a width of the mounted stringer 66. Accordingly, the substrate 50 can be assembled in a narrower package or housing.

Although structures have been described above as being in contact with one another, and may have been illustrated as such, such structures can be offset from one another due to mechanical tolerances and due to design. For example, to accommodate variations in an edge of a substrate 50, the stringer 38 can be offset from the substrate 50. In another example, to optimize the electrical characteristics, the assembly 39 of the cable 8, ferrule 23, and stringer 38 can be offset from the substrate 50.

FIG. 17 is a flowchart illustrating a process for assembling cables to a board according to an embodiment. In 84, the ferrule is attached to the stringer. The ferrule can be press-fit into the stringer. Alternatively or in addition to press-fitting the ferrule into the stringer, the ferrule can be secured in the stringer with solder, conductive epoxy, or the like. In another embodiment, the ferrule can be threaded to be screwed into a similarly threaded opening in the stringer. In another embodiment, a fastener can be used to attach the ferrule to the stringer. Any technique that will create an electrical connection between the shield and the stringer can be used to attach the ferrule to the stringer.

In 82, the cable is attached to the ferrule. In an embodiment, shield of the cable is attached to the ferrule. In an embodiment, the jacket is removed from an end of the cable. The shield is removed from the dielectric, leaving a remaining portion of the shield exposed. The dielectric is removed, exposing the center conductor, but leaving a portion of the dielectric exposed. In an embodiment, the amount of jacket, shield, and dielectric to be removed can be determined based on the selected ferrule. Alternatively, the ferrule can be selected based on the amount of jacket, shield, and dielectric removed.

The cable is inserted into the ferrule and the shield is secured. Any technique that can create an electrical connection can be used to attach shield to the ferrule. For example, solder, conductive epoxy, or the like can be used to secure the shield to the ferrule. In another embodiment, a ring or sleeve can be placed around the shield. The shield can be pulled back from the dielectric around the ring. The cable can be press-fit into the ferrule, with the ring resisting compression and making an electrical contact between the shield and the ferrule.

Although the removal of the dielectric can occur in sequence with the removal of the shield, the removal of the dielectric can occur after the shield is attached to the ferrule. For example, once attached, the dielectric can be trimmed to be flush with the end of the ferrule. The center conductor can be trimmed to expose the desired length. In another example, the dielectric and center conductor can be trimmed after assembly with the stringer.

In 80, the stringer is attached to a substrate. As described above, a variety of techniques can be used to attach the stringer to a substrate. For example, solder, conductive epoxy, or the like can be used to secure the dividers to suitable structures on the substrate. In another example, fasteners can be used to secure the stringer to the substrate. Any combination of such techniques can be used to attach the stringer to the substrate.

In a particular embodiment, the dividers are soldered on to traces, planes, or the like on the substrate. As a result, the dividers and the stringer can act as the reference plane or transfer the reference plane from the substrate to a cable through a ferrule. Furthermore, the amount of solder, epoxy, or the like can be selected to give the resulting structure of the solder, divider, pad, and the like a shape that can be selected to optimize the electrical characteristics of the transition. Similarly, the center conductor can be attached to a signal trace using solder, epoxy, or the like. The amount of solder, epoxy, or the like can be selected to give the resulting structure of the solder, center conductor, pad, and the like a shape that can be selected to optimize the electrical characteristics of the transition.

Although a particular order has been given for the assembly of a cable, ferrule, stringer, and substrate, the above described processes can be performed in any order as desired. For example, the ferrule can be attached to the cable first, then the ferrule can be attached to the stringer.

Having described and illustrated the principles of the invention in embodiments, it should be apparent that the invention can be modified in arrangement and detail without departing from such principles. Accordingly, all modifications and variations coming within the spirit and scope of the above disclosure are included.

1. A cable assembly, comprising:
a cable including:
a center conductor;
a dielectric disposed around the center conductor; and
a shield disposed around the dielectric;
a ferrule electrically connected to the shield and disposed around a portion of the dielectric exposed by the shield; and
a stringer having an opening where the ferrule is disposed in the opening.
